(19) United States
(12) Patent Application Publication
(10) Pub. No.: US 2014/0347315 A1
(43) Pub. Date: Nov. 27, 2014

(54) TOUCH CONTROL METHOD OF CAPACITIVE SCREEN AND DEVICE RELATED THERETO

(71) Applicant: FOCALTECH SYSTEMS, LTD., Grand Cayman (KY)

(72) Inventors: Lianghua MO, Guangdong (CN); Jingkai ZHANG, Guangdong (CN); Huaiyi XU, Guangdong (CN)

(73) Assignee: FOCALTECH SYSTEMS, LTD., Grand Cayman (KY)

(21) Appl. No.: 14/083,252

(22) Filed: Nov. 18, 2013

(30) Foreign Application Priority Data
May 21, 2013 (CN) 201310190603.8

(51) Int. Cl. G06F 3/044

(52) U.S. Cl. CPC G06F 3/044
USPC 345/174

(57) ABSTRACT

A touch control method and a device related thereto are provided. The capacitance touch device includes: a capacitive sensor; a capacitance detection circuit connected to the capacitive sensor and adapted to output a first signal in response of a change of the capacitance of the capacitive sensor in the case of a touch on the capacitance touch device; at least one pressure sensor adapted to sense a pressure produced by the touch on the capacitance touch device; a pressure detection circuit connected to the pressure sensor and adapted to output a second signal based on a sensing result of the pressure sensor; a data processing device connected to the capacitance detection circuit and the pressure detection circuit, and adapted to determine touch control information with pressure information based on the first signal and the second signal.

### CROSS REFERENCE TO RELATED APPLICATION

The present application claims the priority to Chinese Patent Application No. 201310190603.8, filed with the Chinese Patent Office on May 21, 2013, entitled as “TOUCH CONTROL METHOD OF CAPACITIVE SCREEN AND DEVICE RELATED THERETO”, the entire contents of which is incorporated herein by reference in its entirety.

### BACKGROUND

1. Field of the Disclosure

The disclosure relate to techniques in the capacitance touch field, in particular to a touch control method of a capacitive screen, a capacitive touch device and a portable electronic device.

2. Background of the Technology

Existing capacitive screens are widely applied to portable electronic devices because of the advantages of high sensitivities, supporting multi-touch by fingers, etc. The fingers utilized to perform touch control are thick, and hence the touch control with a high accuracy is difficult to be achieved. The efficiency is low when a small button is clicked or writing is performed.

A thin passive pen is provided in some capacitance touch control solutions with ultrahigh sensitivities in the prior art. The tip of the passive pen is similar to that of an actual pen. However, in the case of the writing, only information of a touch position can be sensed, but an actual handwriting input can not be implemented. Although the actual handwriting input can be implemented in the capacitance touch control solutions with an active capacitive pen, the active capacitive pen costs highly and the usage thereof requires a battery, and thus the user experience is poor.

### SUMMARY

Embodiments of the invention provide a touch control method and a touch control device, in which display information such as contents to be displayed and writing traces of a touch pen can be adjusted based on touch control information including pressure information.

Accordingly, in view of a first aspect disclosed herein, a capacitance touch device is provided, which includes:

a capacitive sensor;

a capacitance detection circuit connected to the capacitive sensor, and adapted to output a first signal in response of a change of a capacitance of the capacitive sensor in the case of a touch on the capacitance touch device;

at least one pressure sensor adapted to sense a pressure produced by the touch on the capacitance touch device;

a pressure detection circuit connected to the pressure sensor, and adapted to output a second signal according to a sensing result of the pressure sensor; and

a data processing device connected to the capacitance detection circuit and the pressure detection circuit, and adapted to determine touch control information with pressure information according to the first signal and the second signal.

Preferably, the first signal indicates a touch position, and the second signal indicates a value of the pressure.

Preferably, the capacitance touch device also includes a display module provided under the capacitive sensor. The pressure sensor is provided between a layer with the capacitive sensor and the display module.

Furthermore, the capacitance touch device includes four pressure sensors arranged at four corners of an upper surface of the display module respectively; or arranged at midpoints of four borders of an upper surface of the display module respectively.

Preferably, the capacitance touch device also includes a protective cover plate provided above the capacitive sensor. The pressure sensor is provided between the protective cover plate and the layer with the capacitive sensor.

Furthermore, the capacitance touch device includes four pressure sensors arranged at four corners of an upper surface of the layer with the capacitive sensor respectively; or arranged at midpoints of four borders of the upper surface of the layer with the capacitive sensor respectively.

Preferably, the capacitance touch device also includes the display module and a casing for supporting the display module. The pressure sensor is provided between the display module and the casing.

Furthermore, the capacitance touch device includes four pressure sensors arranged at four corners between the casing and the display module respectively; or arranged on midpoints of four borders between the casing and the display module respectively.

Preferably, the capacitance touch device also includes the protective cover plate provided above the layer with the capacitive sensor and a casing for supporting the protective cover plate, the pressure sensor is provided between the protective cover plate and the casing.

Furthermore, the capacitance touch device includes four pressure sensors arranged at four corners and provided between the protective cover plate and the casing respectively; or arranged on midpoints of four borders and provided between the protective cover plate and the casing respectively.

Preferably, the capacitive sensor is adapted to sense a touch of a passive touch pen on the capacitance touch device, and the pressure sensor is adapted to sense the pressure produced by the touch of the passive touch pen on the capacitance touch device.

Preferably, the data processing device is also adapted to adjust display information according to the touch control information with the pressure information.

Preferably, the display information includes any one or a combination of color and size of a content to be displayed.

Preferably, the display information includes any one or a combination of colors and sizes of points on a handwriting trace of the touch pen.

In view of a second aspect disclosed herein, a portable electronic device is provided, which includes the capacitance touch control device as stated above.

In view of a third aspect disclosed herein, a touch control method is provided, which may include:

detecting a change of a capacitance of a capacitive sensor caused by a touch on a capacitive screen, and determining a touch position according to the detecting result;

sensing a pressure produced by the touch on the capacitive screen, and determining a value of the pressure according to the sensing result; and

determining touch control information with pressure information according to the touch position and the value of the pressure.

Preferably, the sensing the touch on the capacitive screen includes:

sensing the touch of a finger on the capacitive screen by mutual capacitance detection; or

sensing the touch of a passive touch pen on the capacitive screen by self capacitance detection.

In the above technical solutions, the touch control method and the device related thereto as disclosed herein have the following advantages: detecting the touch position with capacitance sensing, detecting the value of the pressure applied by the touch with pressure sensing, determining the touch control information with the pressure information by combining the touch position information and the pressure information. In this way, display information, such as the contents to be displayed and the handwriting traces of the touch pen, is adjusted based on the touch control information with the pressure information, thus improving the client experience and lowering the cost of the solutions.

### BRIEF DESCRIPTION OF THE DRAWINGS

In order to explain technical solutions in the invention's embodiments more clearly, figures for describing the embodiments will be introduced briefly in the following. Obviously, the figures in the following description are only some of the invention's embodiments, and other figures can be obtained by those skilled in the art based on the figures without inventive efforts.

FIG. 1 is a schematic block diagram of a structure of a capacitance touch device according to an embodiment of the invention;

FIG. 2a is a schematic diagram of a structure of a capacitance touch device according to an embodiment of the invention;

FIG. 2b is a sectional diagram of a capacitance touch device according to an embodiment of the invention;

FIG. 3a is a schematic diagram of another structure of a capacitance touch device according to an embodiment of the invention;

FIG. 3b is a sectional diagram of another capacitance touch device according to an embodiment of the invention;

FIG. 3c is a sectional diagram of another capacitance touch device according to an embodiment of the invention;

FIG. 4a is a schematic diagram of another structure of a capacitance touch device according to an embodiment of the invention;

FIG. 4b is a sectional diagram of another capacitance touch device according to an embodiment of the invention;

FIG. 5a is a schematic diagram of another structure of a capacitance touch device according to an embodiment of the invention;

FIG. 5b is a sectional diagram of another capacitance touch device according to an embodiment of the invention;

FIG. 6 is a flow diagram of a touch control method according to an embodiment of the invention;

FIG. 7 is a flow diagram of another touch control method according to an embodiment of the invention; and

FIG. 8 is a schematic diagram of a structure of a portable electronic device according to an embodiment of the invention.

### DETAILED DESCRIPTION

A touch control method and a device related thereto, which can adjust display information such as contents to be displayed and handwriting traces of a touch pen based on touch control information with pressure information, are disclosed herein.

Technical solutions in embodiments of the invention will be described clearly and completely in conjunction with figures in the embodiments of the invention hereinafter. Described embodiments are only part of but not all of the embodiments. All other embodiments obtained by those skilled in the art based on the embodiments described herein without inventive efforts will fall within the scope of the disclosure.

Detailed explanation is given respectively as follows.

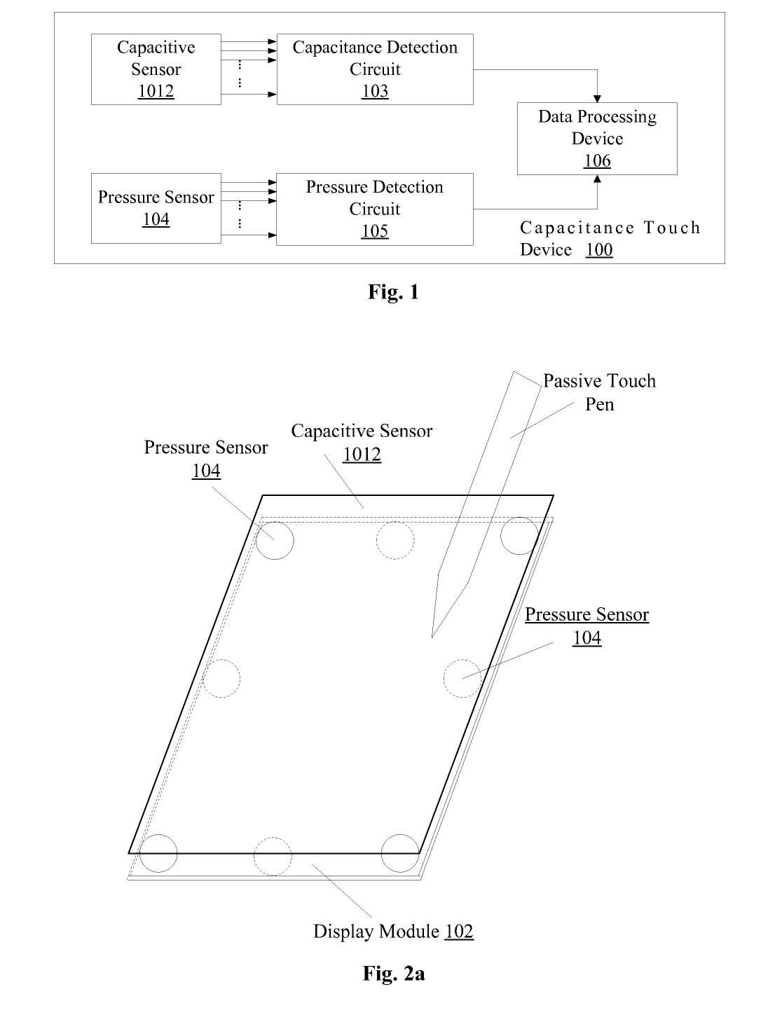

FIG. 1 is a schematic diagram of a structure of a capacitance touch device 100 according to an embodiment of the invention. Referring to FIG. 1, the capacitance touch device 100 includes:

a capacitive sensor 1012;

a capacitance detection circuit 103 connected to the capacitive sensor 1012 and adapted to output a first signal in response to a change of a capacitance of the capacitive sensor 1012 in the case of a touch on the capacitance touch device 100;

at least one pressure sensor 104 adapted to sense a pressure applied on the capacitance touch device 100 by the touch;

a pressure detection circuit 105 connected to the pressure sensor 104, and adapted to output a second signal according to a sensing result of the pressure sensor 104; and

a data processing device 106 connected to the capacitance detection circuit 103 and the pressure detection circuit 105 respectively, and adapted to determine touch control information with pressure information according to the first signal and the second signal.

Preferably, the first signal indicates a touch position, and the second signal indicates the value of the pressure. In this case, the touch control information with the pressure information may be determined by the data processing device 106 based on touch position information and pressure value information.

It can be understood that the capacitive sensor 1012 is provided inside a capacitive screen in the embodiments of the invention. The capacitive screen is also called a capacitive touch screen. Objects touching the capacitance touch device 100 (capacitive touch screen) can be fingers, active touch pens or passive touch pens. The passive touch pen can be an object similar to a pen in design, which has not a power supply or circuit and has conductivity.

Accordingly, with the capacitance touch device 100 according to the embodiments of the invention, the touch position may be determined by capacitance sensing, the value of the pressure may be determined by pressure sensing, and the touch control information with the pressure information may be determined by combining the touch position information and the pressure information. In this way, the display information such as the contents to be displayed and the handwriting traces of the touch pen may be adjusted based on the touch control information with the pressure information, thus improving the client experience and reducing the cost.

In order to understand the technical solutions better, the capacitance touch device disclosed herein is analyzed and explained with the following specific embodiments.

### First Embodiment

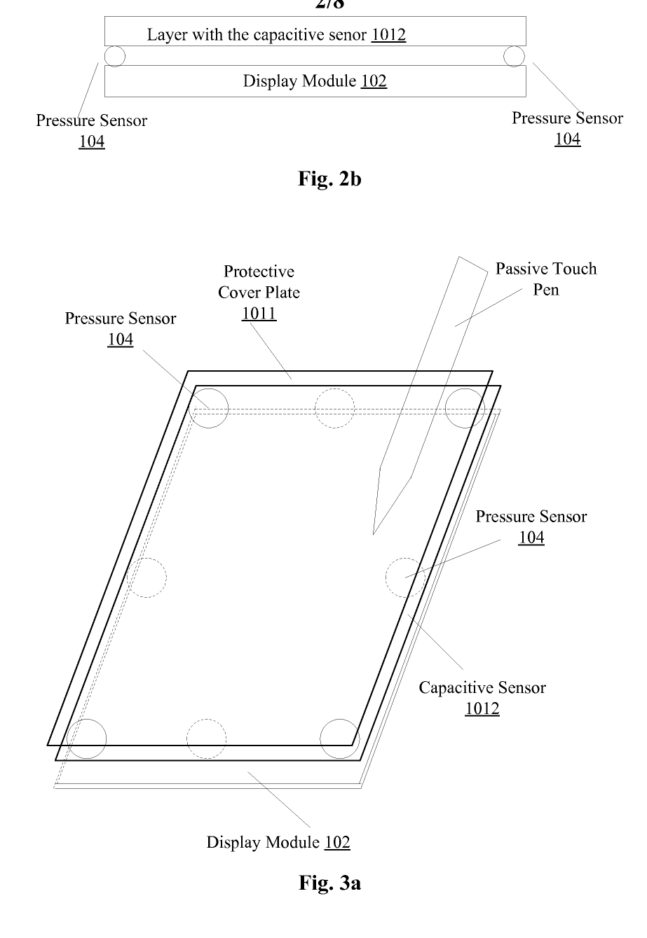

Referring to FIG. 2a and FIG. 2b, FIG. 2a is a schematic diagram of a first example of the capacitance touch device according to an embodiment of the invention, and FIG. 2b is a sectional diagram of the first example of the capacitance touch device according to the embodiment of the invention.

It can be understood that the capacitance touch device according to the embodiment of the invention also includes a display module 102 provided under the capacitive sensor 1012. The display module 102 may be a Liquid Crystal Display Module (LCD Module, LCM). In the first embodiment, the pressure sensor 104 is provided between a layer with the capacitive sensor 1012 and the display module 102. In addition, in the first embodiment, the capacitance touch device includes four pressure sensors 104, which are arranged at four corners of an upper surface of the display module 102. In other words, the pressure sensors 104 are arranged at four corners of a lower surface of the layer with the capacitive sensor 1012. The pressure sensors are marked with solid line circles in FIG. 2a for convenient understanding. In some embodiments, the four pressure sensors 104 may be arranged on midpoints of four borders of the upper surface of the display module 102 respectively. In other words, the pressure sensors 104 are arranged at midpoints of four borders of the lower surface of the layer with the capacitive sensor 1012. The pressure sensors are marked with dotted line circles in FIG. 2a for convenient understanding.

As shown in FIG. 2a, a pressure is applied on the surface of the capacitive screen when the capacitance touch device (the capacitive screen) is touched by the touch object (such as the passive touch pen) in the embodiment, and then the capacitance of the capacitive sensor 1012 changes. The pressure will be transferred to the pressure sensors 104 through the capacitive screen, and then the pressure sensors 104 may sense a pressure change, which is produced by a touch of the passive touch pen on the capacitance touch device. In this way, the touch control information with the pressure information is obtained. Preferably, in the case that the touch object is the passive touch pen, battery does not need to be installed and the cost is low. The capacitive sensor 1012 may be adapted to sense the touch of the passive pen on the capacitance touch device, and the pressure sensors may be adapted to sense the pressure produced by the touch of the passive pen on the capacitance touch device.

In addition it should be noted that the data processing device 106 may further be adapted to adjust the display information based on the touch control information with the pressure information in the first embodiment. The display information may include any one or a combination of colors and sizes of the contents to be displayed in some embodiments. The display information may include any one or a combination of colors and sizes of points on the handwriting traces of the touch pen in some other embodiments.

It is easy to understand that four pressure sensors 104 are provided in the capacitance touch device according to the first embodiment of the invention, and thus much more pressure information may be obtained to implement an accurate sensing. More pressure sensors 104 may be provided in some embodiments with a high accuracy, or the pressure sensors 104 may be arranged at other locations, which are not specified herein.

Accordingly, a capacitance touch device is provided in an embodiment of the invention, in which the touch position may be determined by capacitance sensing, the pressure value may be determined by pressure sensing, and touch control information with pressure information may be determined by combining the touch position information and the pressure information. Thereby, the display information such as the contents to be displayed and the handwriting traces of the touch pen may be adjusted based on the touch control information with the pressure information, thus improving the client experience and reducing the cost.

### Second Embodiment

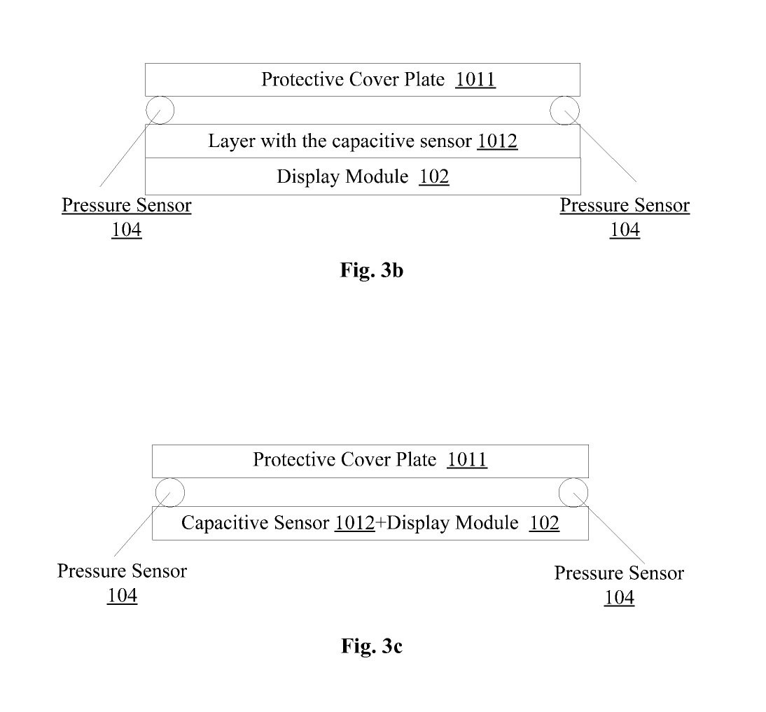

Referring to FIG. 3a and FIG. 3b, FIG. 3a is a schematic diagram of a second embodiment of a capacitance touch device according to the embodiment of the invention, and FIG. 3b is a sectional diagram of the second embodiment of the capacitance touch device according to the embodiment of the invention.

The capacitance touch device according to the embodiment can also include a protective cover plate 1011 provided above the capacitive sensor 1012. The pressure sensor 104 may be located between the protective cover plate 1011 and a layer with the capacitive sensor 1012 in embodiment 2. In addition, the capacitance touch device includes four pressure sensors 104 in the embodiment, which can be arranged at four corners of an upper surface of the layer with the capacitive sensor 1012. In other word, the four pressure sensors are arranged at four corners of a lower surface of the protective cover plate 1011. The pressure sensors are marked with solid line circles in FIG. 3a for convenient understanding. The four pressure sensors 104 may be arranged on midpoints of four borders of the upper surface of the layer with the capacitive sensor 1012 respectively in some embodiments. In other words, the four pressure sensors are arranged on midpoints of four borders of the lower surface of the protective cover plate 1011. The pressure sensors are marked with dotted line circles in FIG. 3a for convenient understanding.

It can be understood that the capacitive screen, i.e., a touch screen module, generally may include the protective cover plate 1011 and the capacitive sensor 1012. Some common touch screen modules are designed into the GFF structure, the GG structure, the GF structure, etc. Particularly, the G in those structures indicates a protective cover plate 1011 with a glass structure. In the touch screen module, the protective cover plate 1011 is bonded to the capacitive sensor 1012 by glue. The OGS structure is also adopted, in which the capacitive sensor 1012 is provided under the protective cover plate 1011, and the protective cover plate 1011 and the capacitive sensor 1012 form an undividable entirety in structure.

The protective cover plate 1011 is completely separated from the capacitive sensor 1012 in some embodiments. That is to say, the protective cover plate 1011 need not be bonded to the capacitive sensor 1012. The pressure sensors 104 can be provided between the protective cover plate 1011 and the layer with the capacitive sensor 1012 in this situation, the structure of which is the same as the schematic diagram of a structure of the capacitance touch device according to the second embodiment shown in FIG. 3a and FIG. 3b. For example, in the In-cell structure, the capacitive sensor 1012 and the display module 102 are provided as an entirety. As shown in FIG. 3c, FIG. 3c is another sectional diagram of the capacitance touch device according to the embodiment of the invention. The capacitance touch device includes a protective cover plate 1011 provided above the display module 102 which includes the capacitive sensor 1012. There is a distance between the protective cover plate 1011 and the upper surface of the display module 102, and the pressure sensors 104 may be arranged between the protective cover plate 1011 and the display module 102.

The capacitive sensor 1012 is connected to the capacitance detection circuit 103 in the embodiment, and thus capacitive touch control information of the touch object (such as the passive touch pen) may be obtained in a timely way. Current pressure touch control information may be obtained by the pressure sensors 104. The touch position may be determined according to the capacitance touch control information, and the pressure of the touch may be determined according to the pressure touch control information. The capacitance touch control information and the pressure touch control information are combined by the data processing device 106 such as Micro Control Unit (MCU) to output the touch control information with the pressure information. Preferably, no battery is needed to be installed and the cost is low when the touch object is the passive touch pen. The capacitive sensor 1012 may be adapted to sense the touch of the passive touch pen on the capacitance touch device, and the pressure sensors 104 may be adapted to sense the pressure caused by the touch of the passive touch pen on the capacitance touch control device.

In addition, it should be noted that the data processing device 106 may also be adapted to adjust the display information according to the touch control information with the pressure information in the second embodiment of the invention. The display information may include any one or a combination of colors and sizes of the contents to be displayed in some embodiments, and the display information may include any one or a combination of colors and sizes of the points on the handwriting traces of the touch pen in some other embodiments.

It is easy to understand that four pressure sensors 104 are provided in the capacitance touch device in the second embodiment of the invention, and thus much more pressure information may be obtained to implement an accurate sensing. More pressure sensors 104 may be provided in some embodiments with higher accuracy, or the pressure sensors 104 may be arranged at other locations, which are not specified herein.

Accordingly, in the capacitance touch device according to the embodiment of the invention, the touch position may be determined by capacitance sensing, the pressure value may be determined by pressure sensing, and the touch position information and the pressure information are combined to determine the touch control information with pressure information. Thereby, the display information such as the contents to be displayed and the handwriting traces of the touch pen may be adjusted based on the touch control information, and the client experience may be improved. Moreover, no battery is needed to be installed and the cost is low in the case that the touch object is the passive touch pen.

### Third Embodiment

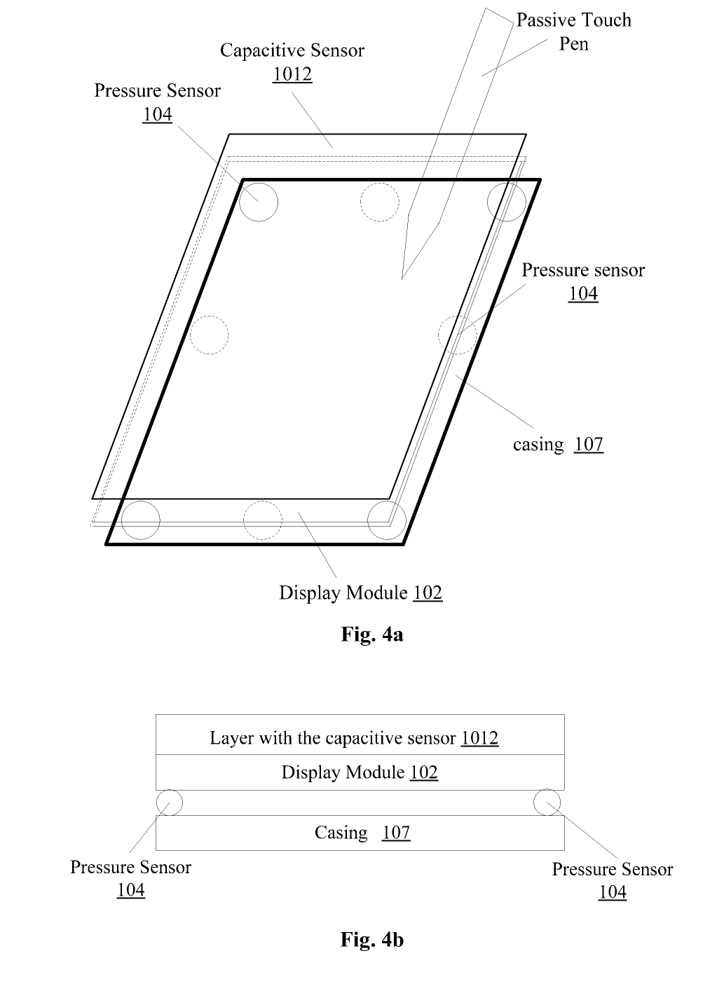

Referring to FIG. 4a and FIG. 4b, FIG. 4a is a schematic diagram of the capacitance touch device according to the third embodiment of the invention, and FIG. 4b is a sectional diagram of the capacitance touch device according to the third embodiment of the invention.

The capacitance touch device according to the embodiment may also include a display module 102 and a casing 107 for supporting the display module. Pressure sensors 104 are provided between the display module 102 and the casing 107 in embodiment 3. In addition, the capacitance touch device includes four pressure sensors 104 in the embodiment, which may respectively be arranged at four corners between the casing 107 and the display module 102, and the pressure sensors are marked with solid line circles in FIG. 4a for convenient understanding. The four pressure sensors 104 may respectively be arranged on midpoints of four borders between the casing 107 and the display module 102 in some embodiments, which are marked with dotted line circles in FIG. 4a for convenient understanding.

It can be understood that the pressure sensors 104 are not suitable to be provided between the capacitive screen and the display module 102 in some situations. Therefore, the pressure sensors 104 may be provided between the display module 102 and the casing 107 for supporting the display module 102 according to the third embodiment shown in FIG. 4a and FIG. 4b. The pressure applied by the touch object (such as the passive touch pen) may be transferred to the display module 102 through the touch screen, and then transferred to the pressure sensors 104 provided below the display module 102 through the display module 102. Preferably, no battery is needed to be installed and the cost is low when the touch object is the passive touch screen. The capacitive sensor 1012 can be adapted to sense the touch of the passive touch pen on the capacitance touch device, and the pressure sensors 104 can be adapted to sense the pressure caused by the touch of the passive touch pen on the capacitance touch device.

In addition, it should be noted that the data processing device 106 can also be adapted to adjust the display information based on the touch control information with the pressure information in the third embodiment of the invention. The display information may include any one or a combination of colors and sizes of the contents to be displayed in some embodiments, and the display information may include any one or a combination of colors and sizes of the points on the handwriting traces of the touch pen in some other embodiments.

It is easy to understand that four pressure sensors 104 are provided in the capacitance touch device in the third embodiment of the invention, thus much more pressure information may be obtained to implement an accurate sensing. More pressure sensors 104 may be provided in some embodiments with higher accuracy, or the pressure sensors 104 may be arranged at other locations, which are not specified herein.

Accordingly, in the capacitance touch device according to the embodiment of the invention, the touch position may be determined by capacitance sensing, the pressure value may be determined by pressure sensing, and the touch position information and the pressure information are combined to determine the touch control information with pressure information. Thereby, the display information such as contents to be displayed and handwriting traces of the touch pen may be adjusted based on the touch control information, and the client experience may be improved. Moreover, no battery is needed to be installed and the cost is low in the case that the touch object is the passive touch pen.

### Fourth Embodiment

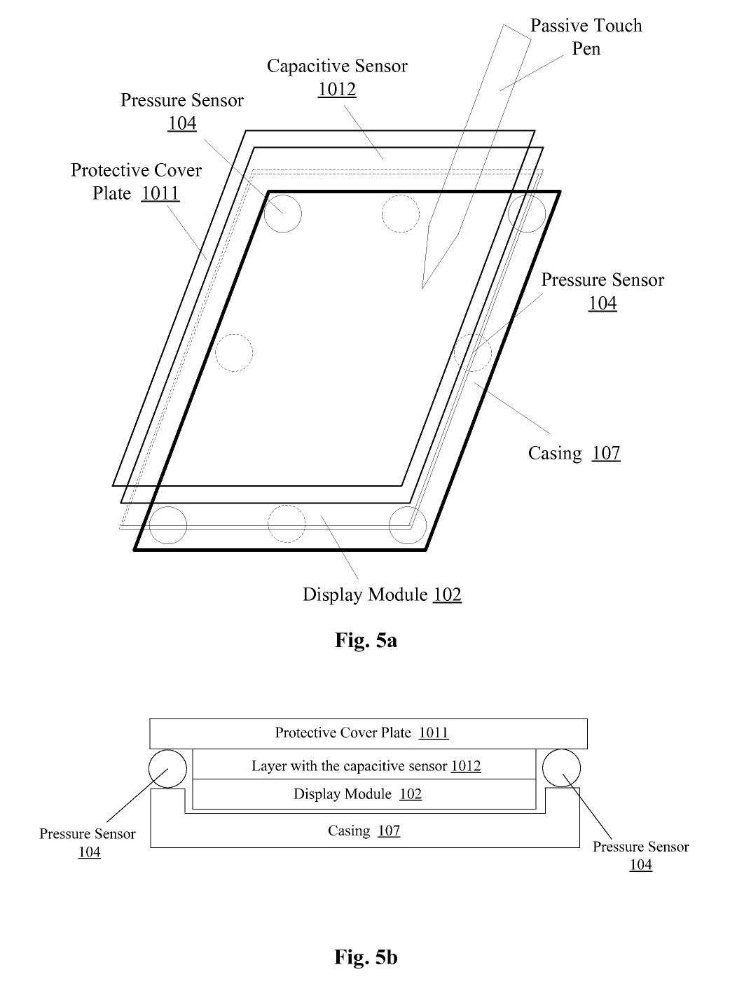

Referring to FIG. 5a and FIG. 5b, FIG. 5a is a schematic diagram of the capacitance touch device according to the fourth embodiment of the invention, and FIG. 5b is a sectional diagram of the capacitance touch device according to the fourth embodiment of the invention.

In the embodiment of the invention, the capacitance touch device may also include a protective cover plate 1011 provided above a layer with the capacitive sensor 1012, and a casing 107 adapted to support the protective cover plate 1011. The pressure sensors 104 are provided between the protective cover plate 1011 and the casing 107 in the fourth embodiment. Particularly, the capacitance touch device includes four pressure sensors 104 in the embodiment, which may respectively be arranged at four corners between the casing and the protective cover plate 1011 supported by the casing 107. The pressure sensors are marked with solid line circles in FIG. 5a for convenient understanding. In some embodiments, the four pressure sensors 104 may respectively be arranged on midpoints of four borders between the protective cover plate 1011 and the casing 107, which are marked with dotted line circles in FIG. 5a for convenience understanding.

It will be understood that the pressure sensors 104 are provided between the protective cover plate 1011 and the casing 107 for supporting the protective cover plate 1011 as shown in FIG. 5a and FIG. 5b. The pressure produced by a touch object (such as a passive touch pen) will be transmitted to the pressure sensors 104 through the protective cover plate 1011. Preferably, no battery is needed to be installed and the cost is low when the touch object is the passive touch screen. The capacitive sensor 1012 may be adapted to sense the touches of the passive touch pen on the capacitance touch device. The pressure sensors 104 may be adapted to sense the pressures caused by the touches of the passive touch pen on the capacitance touch device.

In addition, it should be noted that in the fourth embodiment of the invention, the data processing device 106 may also be adapted to adjust the display information based on the touch control information with the pressure information. The display information can include any one or a combination of colors and sizes of the contents to be displayed in some embodiments. The display information may include any one or a combination of colors and sizes of the points on the handwriting traces of the touch pen in some other embodiments.

It is easy to understand that four pressure sensors 104 are provided in the capacitance touch device in the fourth embodiment of the invention, and thus much more pressure information may be obtained to implement an accurate sensing. More pressure sensors 104 may be provided in some embodiments with a high accuracy, or the pressure sensors 104 may be arranged at other locations, which are not specified herein.

Accordingly, a capacitance touch device is provided according to the embodiment of the invention, in which the touch position may be determined by capacitance sensing, the pressure value may be determined by pressure sensing, and the touch control information with pressure information may be determined by combining the touch position information and the pressure information. Thereby, the display information, such as contents to be displayed and handwriting traces of the touch pen, can be adjusted based on the touch control information, thus improving the client experience. Moreover, no battery is needed to be installed and the cost is low in the case that the touch object is the passive touch pen.

In order to implement the capacitance touch device according to the embodiments of the invention better, a capacitive screen touch control method applied to the capacitance touch device, and a portable electronic device including the capacitance touch device are also provided in the embodiments of the invention. In this embodiment, meanings of nouns are the same as those in the capacitance touch device, and specific implementation details may be referred to explanations in the embodiments about the capacitance touch device.

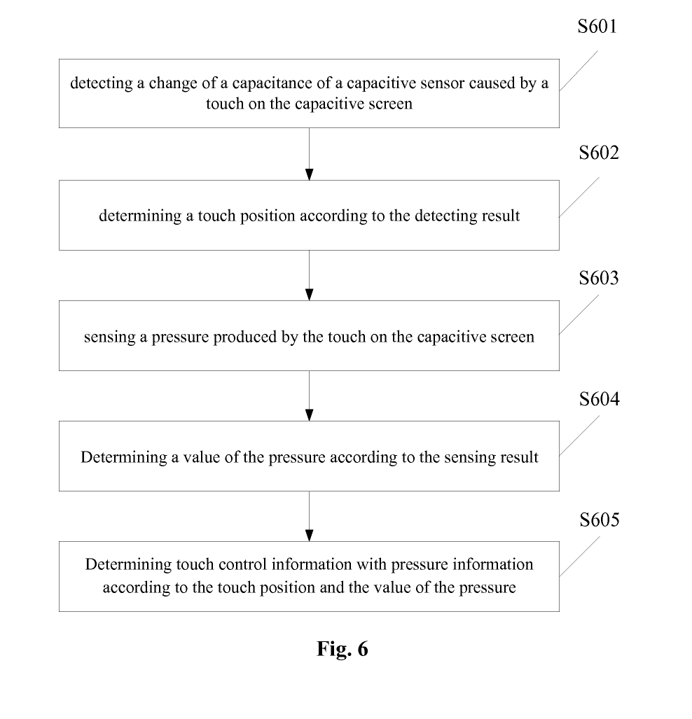

Referring to FIG. 6, a flow diagram of a capacitive screen touch control method is shown according to the embodiment of the invention. The capacitive screen touch control method is applied to the capacitance touch device according to the embodiments. The method can include steps S601-S605.

S601: detecting a change of a capacitance of a capacitive sensor caused by a touch on a capacitive screen.

S602: determining a touch position according to the detecting result.

S603: sensing a pressure produced by the touch on the capacitive screen.

S604: determining a value of the pressure according to the sensing result.

S605: determining touch control information with pressure information according to the touch position and the value of the pressure.

It will be understood that a touch object for touching the capacitance touch device (for touching the capacitive screen) may be a passive touch pen in the embodiment of the invention. The passive touch pen may be an object similar to an actual pen in design, but without a source or circuit, and having a certain conductivity. For example, the passive touch pen can be designed as a tiny pen with a conductive tip.

Furthermore, sensing the touch on the capacitive screen (Step S603) may specifically include:

sensing the touch of a finger on the capacitive screen by mutual capacitance detection; Or,

sensing the touch of the passive touch pen on the capacitive screen by self capacitance detection.

That is to say, the capacitance touch device is configured with two kinds of working modes, which includes a normal mode and a high sensitivity mode. It will be understood that the mutual capacitance detection may be adopted in the normal mode, and the self capacitance detection may be adopted in the high sensitivity mode.

Preferably, in the case that the mutual capacitance detection is adopted, the touch of the passive touch pen on the capacitance touch device may be sensed by the capacitive sensor 1012 of the capacitance touch device, and the pressure produced by the touch of the passive touch pen on the capacitance touch device may be sense by the pressure sensors 104.

Accordingly, a capacitive screen touch control method is provided according to the embodiment of the invention, in which the touch position may be determined through capacitance sensing, a value of the pressure may be determined through pressure sensing, and the touch control information with the pressure information may be determined by combining the touch position information and the pressure information. Thereby, display information, such as contents to be displayed and handwriting traces of the touch pen, may be adjusted based on the touch control information, thus improving the client experience. Moreover, no battery is needed to be installed and the cost is low if the touch object is the passive touch pen.

In order to understand the implementation of the capacitive screen touch control method better, the capacitive screen touch control method disclosed herein will be analyzed and explained with a specific embodiment as follows.

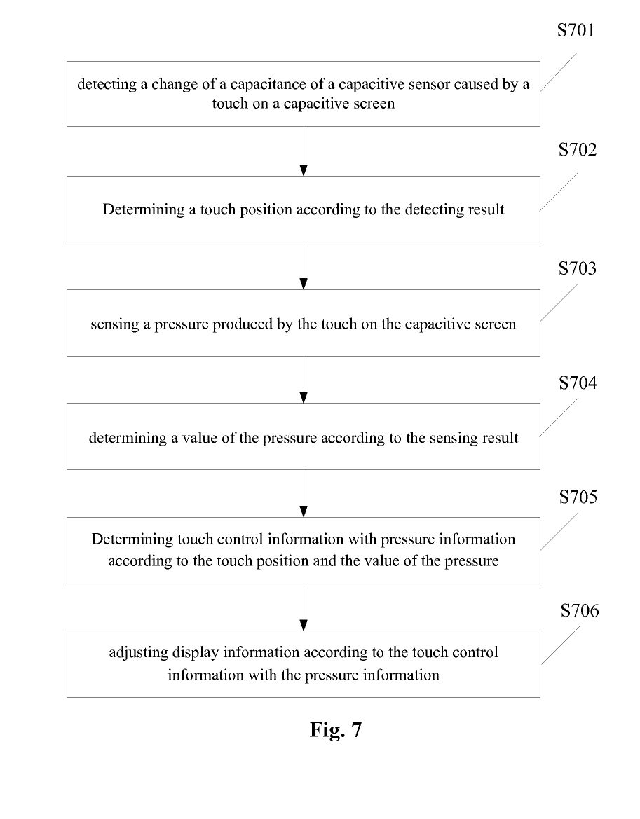

Referring to FIG. 7, a flow diagram of the capacitive screen touch control method is shown according to the embodiment of the invention. A subject for performing the method may be a capacitance touch device. The method can include steps S701-S706.

S701: detecting a change of a capacitance of a capacitive sensor caused by a touch on a capacitive screen.

S702: determining a touch position according to the detecting result.

That is to say, capacitance touch control information is obtained and detected by the capacitance touch device to determine the touch position of a touch object.

S703: sensing a pressure produced by the touch on the capacitive screen.

The pressure produced by the touch of a finger on the capacitive screen is sensed by mutual capacitance detection; or the pressure produced by the touch of a passive touch pen on the capacitive screen is sensed by self capacitance detection.

In some application scenarios where the passive touch pen is adapted to touch the capacitive screen and the self capacitance detection is adopted, the touch of the passive touch pen on the capacitance touch device may be sensed by the capacitive sensor 1012 of the capacitance touch device, and the pressure produced by the touch of the passive touch pen on the capacitance touch device may be sensed by the pressure sensors 104.

S704, determining a value of the pressure according to the sensing result.

That is to say, pressure touch control information is obtained and detected by the capacitance touch device to determine the value of the pressure produced by the touch of the passive touch pen on the capacitance touch device.

S705, determining touch control information with pressure information according to the touch position and the value of the pressure.

It will be understood that the sampling rate of the capacitance touch control information is different from that of the pressure touch control information, thus it is necessary to synchronize the capacitance touch control information and the pressure touch control information. Particularly, the pressure touch control information and location information at suitable time points are combined together and synchronized. There are many kinds of methods for synchronization, which can be determined in actual situations, and specific limits are not given here.

A filter interpolation method may be used in the embodiment. The pressure information is interpolated at the sample frequency of the capacitance touch control information and then the interpolated pressure information is sampled to implement the synchronization. Alternatively, the sample period of the capacitance touch control information is set as an integer multiple of the sample period of the pressure touch control information, or the sample period of the pressure touch control information is set as an integer multiple of the sample period of the capacitance touch control information, then the higher sampling frequency is set as a frequency of a final result while the sampling data with the lower sampling frequency may also be outputted at the higher sampling frequency after the interpolation, and finally the synchronization is implemented. Alternatively, one identical clock on the capacitance touch control information and the pressure touch control information is adopted in the circuit design to implement the synchronization. In addition, a change of the pressure is slower than that of the capacitance touch control information, and thus data filtering and smoothing may be performed on the pressure touch control information to produce a better utilization experience effect.

S706, adjusting display information according to the touch control information with the pressure information.

Preferably, after the touch control information with the pressure information is obtained, the display information (brushwork) can be adjusted by the touch control information. The display information may include any one or a combination of colors and sizes of the contents to be displayed in some embodiments, and may include any one or a combination of colors and sizes of the points on the handwriting traces of the touch pen in some other embodiments. That is to say, the brushwork of a certain point may be adjusted according to the touch control information, and then the handwriting traces, i.e. the brushworks of multiple points, may be adjusted according to the touch control information.

Those skilled in the art will appreciate that specific operation process of the above touch control method may be referred to the related procedures in the embodiments of the capacitance touch device, which are not mentioned here for the convenience and briefness of the description.

Accordingly, in the capacitive screen touch control method according to the embodiment of the invention, the touch position may be detected by capacitance sensing, the value of the pressure may be detected by pressure sensing, and the touch control information with the pressure information may be determined by combining the touch position information and the pressure information. Therefore, the display information, such as the contents to be displayed and the handwriting traces of the touch pen, can be adjusted based on the touch control information, thus improving the client experience. In addition, no battery is needed to be installed and the cost is low when the touch object is the passive touch pen.

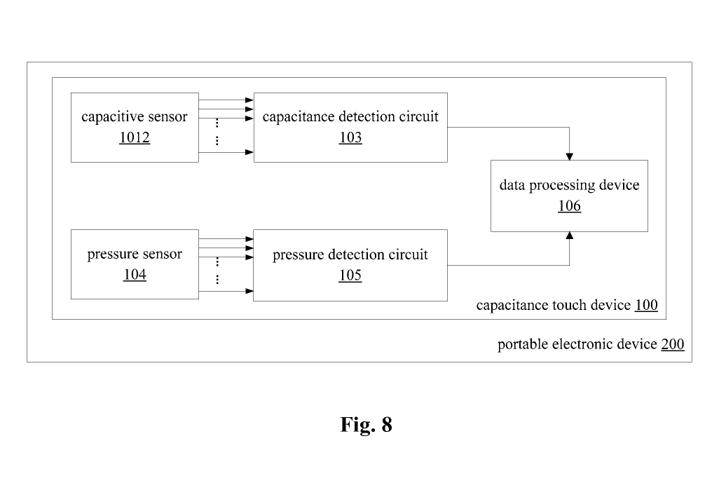

Further preferably, a portable electronic device 200 is provided according to the embodiment of the invention. Referring to FIG. 8, a schematic structure diagram of the portable electronic device 200 is shown according to the embodiment of the invention. The portable electronic device 200 includes the capacitance touch device 100 as described above in the embodiment. That is to say, the capacitance touch device 100 in the embodiment may be applied to the portable electronic device 200.

Optionally, the portable electronic device may also include a display. The capacitance touch device 100 is provided above the display in some embodiments. The capacitance touch device 100 and the display can be designed into integration, i.e. a unity, in some other embodiments, which will not be limited specifically herein.

The portable electronic device 200 can be a mobile phone, a tablet or other portable electronic devices, which will not be limited specifically herein.

It is obvious to those skilled in the art that specific operation process of the capacitance touch device in the portable electronic device 200 may be referred to the related procedures of the capacitance touch device in the above embodiment, which is not mentioned here for the convenience and briefness of the description.

Accordingly, a portable electronic device 200 is provided according to the embodiment of the invention, which includes the capacitance touch device 100 described in the above embodiment. In the capacitance touch control device 100, the touch position may be detected by capacitance sensing, the value of the pressure may be detected by pressure sensing, and the touch control information with the pressure information may be determined by combining the touch position information and the pressure information. Therefore, the display information, such as the contents to be displayed and the handwriting traces of the touch pen, may be adjusted according to the touch control information, thus improving the client experience. In addition, no battery is needed to be installed and the cost is low when the touch object is the passive touch pen.

It is obvious to those skilled in the art that specific operation processes of the touch control method and the portable electronic device may be referred to the related procedures in the embodiments of the capacitance touch device, which are mentioned here for the convenience and briefness of the description.

It should be understood according to the embodiments of the invention that the system, device and method can be implemented in other ways. For example, the embodiment of device as described above is schematic. For example, in the device, the units are divided based on logic functions, which may be divided in other manners for actual implementation, such as the combination or integration of multiple units or modules into one system, or a neglect or inexecution of some characteristics. In addition, the shown or discussed mutual coupling, direct coupling or communication connection may be an indirect coupling or communication connection via some interfaces, device or units, which may be in electrical, mechanical or other ways.

The unit as a divided component may be physically divided or not. A component shown as a unit may be a physical unit or not, which may be located at one place or may be distributed at multiple network units. Part of or all the units may be chosen to realize objects of the embodiments.

In addition, function units in the embodiments of the invention may be integrated in one processing unit or exist as some separated physical units. Two or more function units may be integrated into one unit, too. The integrated units can be implemented by hardware or software function units.

The integrated units, which are implemented through software function units and are sold or utilized as independent products, can be stored in a readable computer storage medium. Accordingly, the essence of the technical solution of embodiments of the invention, the part which contributes to the prior art, or part of or all the technical solution can be represented through a software product. The computer software product, which is stored in a storage medium, includes several instructions which are adapted to make a computer device (e.g., a personal computer, a server, a network device, etc) execute part of or all the procedures of the method according to each embodiment of the invention. The storage medium can be a USB Flash Disk, a Mobile Hard Disk Drive, a Read-Only Memory (ROM), a Random Access Memory (RAM), a disk, a Compact Disk or other mediums which can store program codes.

Detailed description is given to the touch control method and the device related thereto according to various embodiments of the invention. Those skilled in the art will recognize that changes may be made on specific implementation manner and the application scope in the scope of the mind of the embodiments of the invention. The invention will not be limited by the contents of the specification.

What is claimed is:

1. A capacitance touch device, comprising:
a capacitive sensor;
a capacitance detection circuit connected to the capacitive sensor, and adapted to output a first signal in response of a change of capacitance of the capacitive sensor in the case of a touch on the capacitance touch device;
at least one pressure sensor adapted to sense a pressure produced by the touch on the capacitance touch device;
a pressure detection circuit connected to the pressure sensor, and adapted to output a second signal according to a sensing result of the pressure sensor; and
a data processing device connected to the capacitance detection circuit and the pressure detection circuit, and adapted to determine touch control information with pressure information according to the first signal and the second signal.

2. The device according to claim 1, wherein the first signal indicates a touch position, and the second signal indicates a value of the pressure.

3. The device according to claim 1, wherein the capacitance touch device further comprises a display module provided under the capacitive sensor, and the pressure sensor is provided between a layer with the capacitive sensor and the display module.

4. The device according to claim 3, wherein the capacitance touch device comprises four pressure sensors arranged at four corners of an upper surface of the display module respectively; or arranged on midpoints of four borders of an upper surface of the display module respectively.

5. The device according to claim 1, wherein the capacitance touch device further comprises a protective cover plate provided above the capacitive sensor, and the pressure sensor is disposed between the protective cover plate and a layer with the capacitive sensor.

6. The device according to claim 5, wherein the capacitance touch device comprises four pressure sensors arranged at four corners of an upper surface of a layer with the capacitive sensor respectively; or arranged on midpoints of four borders of an upper surface of a layer with the capacitive sensor respectively.

7. The device according to claim 1, wherein the capacitance touch device further comprises a display module and a casing for supporting the display module, and the pressure sensor is provided between the display module and the casing.

8. The device according to claim 7, wherein the capacitance touch device comprises four pressure sensors arranged at four corners between the casing and the display module respectively; or arranged on midpoints of four borders between the casing and the display module respectively.

9. The device according to claim 1, wherein the capacitance touch device further comprises a protective cover plate provided above a layer with the capacitive sensor and a casing for supporting the protective cover plate, and the pressure sensor is provided between the protective cover plate and the casing.

10. The device according to claim 9, wherein the capacitance touch device comprises four pressure sensors arranged at four corners between the protective cover plate and the casing respectively; or arranged on midpoints of four borders between the protective cover plate and the casing respectively.

11. The device according to claim 1, wherein the capacitive sensor is adapted to sense a touch of a passive touch pen on the capacitance touch device, and the pressure sensor is adapted to sense the pressure produced by the touch of the passive touch pen on the capacitance touch device.

12. The device according to claim 1, wherein the data processing device is further adapted to adjust display information according to the touch control information with the pressure information.

13. The device according to claim 12, wherein the display information comprises any one or a combination of colors and sizes of contents to be displayed.

14. The device according to claim 12, wherein the display information comprises any one or a combination of colors and sizes of points on handwriting traces of the touch pen.

15. A portable electronic device, comprising a capacitance touch device,
wherein the capacitance touch device comprises
a capacitive sensor;
a capacitance detection circuit connected to the capacitive sensor, and adapted to output a first signal in response of a change of capacitance of the capacitive sensor in the case of a touch on the capacitance touch device;
at least one pressure sensor adapted to sense a pressure produced by the touch on the capacitance touch device;
a pressure detection circuit connected to the pressure sensor, and adapted to output a second signal according to a sensing result of the pressure sensor; and
a data processing device connected to the capacitance detection circuit and the pressure detection circuit, and adapted to determine touch control information with pressure information according to the first signal and the second signal.

16. A touch control method of a capacitive screen, comprising:
detecting a change of a capacitance of a capacitive sensor caused by a touch on the capacitive screen, and determining a touch position according to the detecting result;
sensing a pressure produced by the touch on the capacitive screen, and determining a value of the pressure according to the sensing result; and
determining touch control information with pressure information according to the touch position and the value of the pressure.

17. The method according to claim 16, wherein sensing a pressure produced by the touch on the capacitive screen comprises:
sensing the touch of a finger on the capacitive screen by mutual capacitance detection; or
sensing the touch of a passive touch pen on the capacitive screen by self capacitance detection.
